(19) United States
(12) Patent Application Publication
(10) Pub. No.: US 2006/0012155 A1
(43) Pub. Date: Jan. 19, 2006

(54) VEHICLE SIDE AIRBAG APPARATUS AND SEAT CONTAINING SAME

(75) Inventors: Leonard Shaner, New Baltimore, MI (US); James Bederka, Northville, MI (US); David Zhao, Northville, MI (US); Jason Sobick, Royal Oak, MI (US); Michael Stiyer, Grosse Pointe Farms, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 10/710,314

(22) Filed: Jul. 1, 2004

(51) Int. Cl. B60R 21/20

(52) U.S. Cl. 280/730.2

(57) ABSTRACT

A side airbag apparatus for a vehicle is provided. The airbag apparatus includes an airbag that has a generally wedge shaped rear aspect when deployed. The generally wedge shaped rear aspect narrows from an upper region to a lower region. This configuration inhibits loading on the thorax of an occupant of the vehicle seated adjacent the deployed airbag. The airbag apparatus also includes an inflator, which cooperates with the airbag to supply gas thereto. Because the airbag is specifically configured to inhibit loading on an occupant's thorax, the inflator can be configured to inflate the airbag with a pressure greater than typical side airbags.

### BACKGROUND OF INVENTION

1. Field of the Invention

The present invention relates to a vehicle side airbag apparatus and a seat containing such an airbag apparatus.

2. Background Art

Many vehicles today contain side airbags, the purpose of which is to protect a vehicle occupant when the vehicle is involved in a side impact collision. These side airbags may be mounted to a vehicle seat, or may be located under a portion of the interior trim. Side airbags typically attempt to provide some thorax/abdominal coverage for the vehicle occupant, and may also be configured to protect an occupant's head area. Alternatively, the side airbag may work in conjunction with an air curtain, which may deploy downward from the vehicle headliner.

In order to reduce the loading on the thorax—i.e., the upper body, including the ribs—some side airbags are inflated or vented to a lower pressure than may otherwise be desirable. For example, an occupant's shoulder and pelvic area can typically sustain higher loading than the thorax region, and therefore, may benefit by an airbag having a higher pressure. One way to address this situation is to provide a side airbag which is configured to contact the upper regions of an occupant's body, and to also provide a separate, pelvic airbag, configured to contact the lower regions of the occupant's body. Another attempt to deal with this issue is described in U.S. patent application Publication No. 2003/0168836 filed by Sato et al., and published on Sep. 11, 2003. Sato et al. describes an airbag apparatus having upper and lower portions, and an intermediate portion therebetween. The intermediate portion is located to correspond with the thorax of a seated occupant. The airbag apparatus of Sato et al. includes a limiting mechanism that limits the bulging of the intermediate portion such that the thickness of the intermediate portion is less than the thickness of the upper and lower portions. The airbag apparatus of Sato et al. is thus configured to contact an occupant's shoulder and pelvic region, while maintaining a space between the deployed airbag and the occupant's thorax. One limitation of the Sato et al. airbag apparatus, is that it requires multiple chambers in the airbag, which significantly increases the complexity of the airbag apparatus. Moreover, the limiting mechanism used by Sato et al. to limit the bulging of the intermediate portion further adds complexity to the airbag apparatus, which may increase both labor and material costs.

Therefore, a need exists for a vehicle side airbag apparatus that inhibits loading on the thorax of a vehicle occupant, and also keeps down production costs.

### SUMMARY OF INVENTION

Accordingly, the present invention provides a vehicle side airbag apparatus and a vehicle seat including a side airbag apparatus, wherein thorax loading on a seated occupant is inhibited and manufacturing costs are kept down.

The invention also provides a side airbag apparatus for a vehicle, including an airbag having a generally wedge shaped rear aspect when deployed. The generally wedge shaped rear aspect narrows from an upper region to a lower region, thereby inhibiting loading on the thorax of an occupant of the vehicle seated adjacent the deployed airbag. The airbag apparatus also includes an inflator cooperating with the airbag to supply gas thereto, thereby facilitating deployment of the airbag.

The invention further provides an airbag apparatus for a vehicle, including an airbag having a generally wedge shaped rear aspect when deployed. The generally wedge shaped rear aspect narrows from an upper region to a lower region, thereby inhibiting loading on the thorax of an occupant of the vehicle seated adjacent the deployed airbag. The airbag also has a side aspect including first and second portions. The first portion is generally triangular, and narrows from a back region to a front region, thereby further inhibiting loading on the thorax of an occupant of the vehicle seated adjacent the deployed airbag. The second portion is contiguous with the first portion and includes at least one mounting hole. An inflator is configured for attachment to the airbag at the at least one mounting hole, and cooperates with the airbag to supply gas thereto. This facilitates deployment of the airbag.

The invention also provides a vehicle seat including a side airbag apparatus. The airbag apparatus includes an airbag having a generally wedge shaped rear aspect when deployed. The generally wedge shaped rear aspect narrows from an upper region to a lower region, thereby inhibiting loading on the thorax of an occupant of the vehicle seated adjacent the deployed airbag. An inflator is mounted on a portion of the seat, and cooperates with the airbag to supply gas thereto, thereby facilitating deployment of the airbag.

### BRIEF DESCRIPTION OF DRAWINGS

FIG. 1 shows a side view of a vehicle seat and airbag apparatus in accordance with the present invention;

FIG. 2 shows a side plan view of the airbag shown in FIG. 1;

FIG. 3 shows a rear plan view of the airbag and inflator shown in FIG. 1;

FIG. 4 shows a top plan view of the airbag and inflator; and

FIG. 5 shows a top plan view of the vehicle seat and airbag apparatus shown in FIG. 1, relative to a portion of a vehicle door panel.

### DETAILED DESCRIPTION

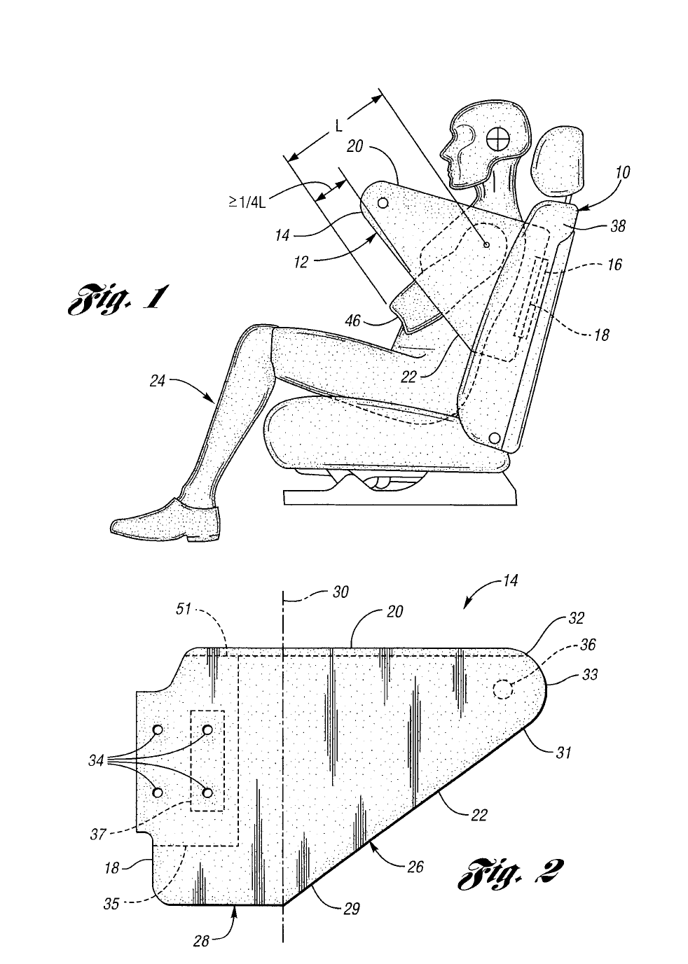

FIG. 1 shows a vehicle seat 10 including an airbag apparatus 12 in accordance with the present invention. The airbag apparatus 12 includes an airbag 14 and an inflator 16, which cooperates with the airbag 14 to supply gas to the airbag 14, thereby facilitating deployment of the airbag 14. In the embodiment shown in FIGS. 1 and 2, the airbag 14 has a generally wedge shaped side aspect when deployed. The generally wedge shaped side aspect includes a posterior edge 18, a top edge 20 which extends forward from the posterior edge 18, and a bottom edge 22, a portion of which extends forward and upward from the posterior edge 18.

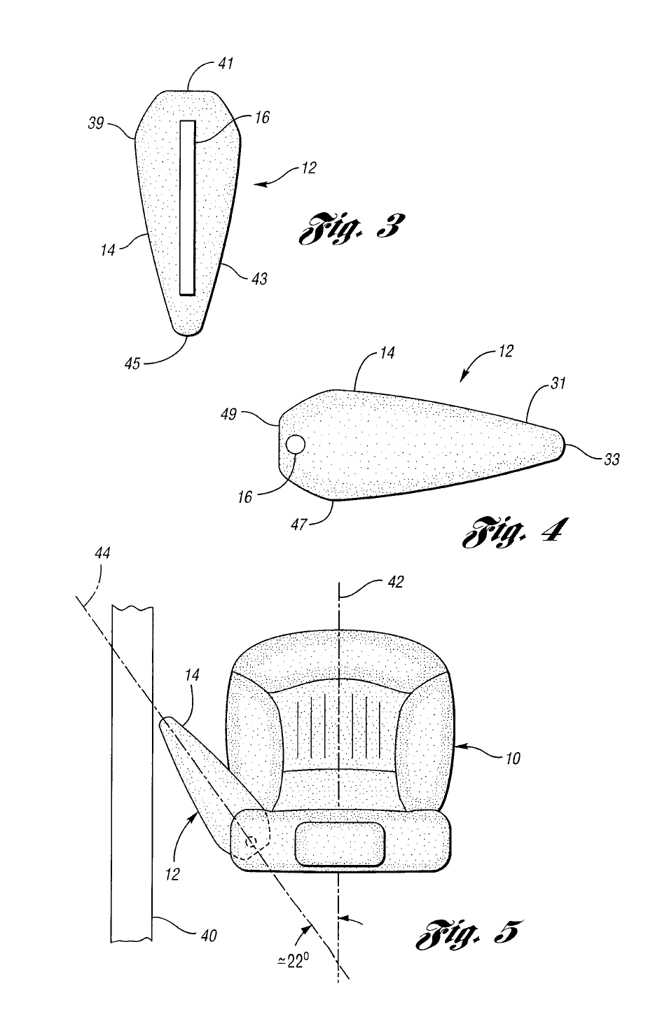

The wedge shaped side aspect of the airbag 14 helps to inhibit loading on the thorax of an occupant 24 seated adjacent the deployed airbag 14. As explained below, in conjunction with FIG. 3, the airbag 14 also has a generally wedge shaped rear aspect. Having a rear aspect that is wedge shaped allows the side aspect to be non-wedge shaped—e.g., rectangular, round, etc.—while still inhibiting loading on the thorax of the vehicle occupant.

FIG. 2 shows a side view of the airbag 14 prior to installation into the vehicle seat 10. As shown in FIG. 2, the airbag 14 may be generally divided into first and second portions 26, 28. For convenience, an axis 30 is shown to represent a line of demarcation between the two airbag portions 26, 28. It is worth noting that the first and second portions 26, 28 merely divide the airbag 14 according to the geometry of its side aspect. Although an airbag, such as the airbag 14, may be divided internally into one or more chambers, the first and second portions 26, 28 of the airbag 14 denote a convenient means for describing the shape of the airbag 14, which is configured to inhibit loading on the thorax of a vehicle occupant.

As shown in FIG. 2, the first portion 26 of the airbag 14 is generally triangular, and narrows from a back region 29, adjacent the axis 30, to a front region 31, adjacent the front 33 of the airbag 14. It is clear that the first portion 26 is not precisely a triangle, but rather, includes a rounded corner 32. The rounded corner 32 helps to eliminate stress concentrations that could occur in an airbag having a sharp corner. This provides another benefit, because, as explained below, it allows the airbag 14 to be inflated to a higher pressure than typical side airbags.

The generally triangular shape of the first portion 26 provides a loading on the shoulder and upper arm of a vehicle occupant, such as the vehicle occupant 24 shown in FIG. 1. At the same time, because a portion of the bottom edge 22 extends forward and upward, the airbag 14 will have little or no contact with the lower arm of a vehicle occupant, or the occupant's ribs. Without such a configuration, a side airbag may directly impact the thorax of a vehicle occupant, or alternatively, may impact an occupant's lower arm, thereby driving the lower arm into the thorax region. In contrast, the airbag 14 eliminates that portion of an airbag that would cause a high degree of rib loading on a vehicle occupant.

The second portion 28 of the airbag 14 is contiguous with the first portion 26, and includes a number of mounting holes 34. The mounting holes 34 are provided to attach the inflator 16 to the airbag 14. This can be done in any convenient manner, for example, by using an inflator having threaded studs extending outward that can traverse the holes 34, and allow the inflator to be attached to a seat, such as the seat 10. Although the mounting holes 34 go through the airbag 14, they are isolated from that portion of the airbag 14 that is filled with gas by the inflator 16. As shown in FIG. 2, the airbag 14 also includes reinforced regions 35, 37, around the mounting holes 34 for providing additional strength to the airbag 14. In the regions 35, 37, additional pieces of material are sewn into the airbag 14 to help ensure that the airbag 14 will maintain its integrity if it is inflated to a relatively high pressure, even at elevated temperatures.

An optional vent hole 36 is provided in one side of the airbag 14 to facilitate venting of the gas from the airbag 14. Because the gas may be vented at a high pressure, a vent hole, such as the vent hole 36, will typically be located on the side of the airbag away from the occupant—i.e., the side facing the vehicle door. Although the vent hole 36 need not be of any particular size, a vent hole having a radius of up to 25 millimeters (mm) has been found to be effective to vent gas from the airbag, and at the same time reduce the stress concentrations associated with a structural discontinuity, such as a hole.

The shape of the airbag 14 also provides advantages for packaging the airbag apparatus 12 within a vehicle seat, such as the seat 10. For example, the front portion of the airbag 14, defined in part by the rounded corner 32, can be rolled backward until it reaches an inflator, such as the inflator 16, mounted at the mounting holes 34. Thus, the airbag 14 does not require an elaborate scheme of folding portions into a complex geometrical configuration in order to ensure proper deployment. Rather, the generally triangular shape of the first portion 26 allows the airbag 14 to be quickly rolled into a packaged configuration. This saves labor costs and reduces assembly time.

In addition, because the first portion 26 has a generally triangular shape and narrows from the back region 29 to the front region 31, it is generally easier to deploy through a tear seam in a cover material, such as the upholstery 38 on the seat 10. In particular, because the smaller, front region 31 of the airbag 14 contacts the tear seam in the cover material, there is a higher stress on the tear seam than if the front region 31 of the airbag 14 were as large as the back region 29. Another benefit of the generally triangular shaped first portion is that the airbag 14 requires less material than airbags having, for example, rectangular side aspects. This results in lower airbag costs, and reduced package space, thereby allowing the airbag 14 to be used in a wide variety of vehicle seats and vehicle platforms.

In addition to inhibiting thorax loading because of its generally wedge shaped side aspect, the airbag 14 also inhibits loading on an occupant's thorax by having a generally wedge shaped rear aspect. FIG. 3 shows the rear aspect of the airbag apparatus 12, including the airbag 14 and the inflator 16. As shown in FIG. 3, the airbag 14 has a generally wedge shaped rear aspect that narrows from an upper region 39, adjacent the top 41 of the airbag 14, to a lower region 43, adjacent the bottom 45 of the airbag 14. This provides the maximum contact with a vehicle occupant near the top 41 of the airbag 14, which coincides with the shoulder of the vehicle occupant. Because the shoulder can absorb relatively high loading, this design provides a maximum loading where the vehicle occupant is best suited to receive it. In addition, because the lower portion of the rear aspect is narrowed, less of the airbag 14 contacts the thorax of the vehicle occupant, and it is less likely to contact the lower portion of the occupant's arm, thereby driving the arm into the thorax.

The airbag 14 also has a generally wedge shaped top aspect, as shown in FIG. 4. The generally wedge shaped top aspect narrows from a posterior region 47, adjacent the rear 49 of the deployed airbag 14, to the front region 31. This also helps to provide a maximum loading at an occupant's shoulder, where the occupant is best able to receive it. In addition, because the airbag 14 has a generally wedge shaped top aspect, it is much more easily adapted to smaller vehicles than are non-wedge shaped airbags. For example, FIG. 5 shows a top view of the vehicle seat 10, the airbag apparatus 12 with the airbag 14 deployed, and a portion of a vehicle door panel 40. Although larger vehicles, such as sport utility vehicles (SUV's) may provide ample room between a vehicle seat and the vehicle door trim panel or B-pillar trim, smaller vehicles are often much more tightly packaged.

The reduced space between the vehicle seat and the aforementioned trim components requires special considerations for side airbags. For example, it may be undesirable to have a side airbag impact the vehicle door trim panel or B-pillar trim as it deploys. Therefore, in certain vehicle architectures, where the space between the vehicle seat and the vehicle door trim panel or B-pillar trim is relatively constrained, it may be necessary to orient the airbag with a smaller forward angle.

FIG. 5 shows that the vehicle seat 10 includes a longitudinal seat axis 42. Moreover, the deployed airbag 14 defines an airbag axis 44. In larger vehicles, it may be possible to mount an airbag apparatus such that the airbag axis forms an angle with the longitudinal seat axis that is 30° or greater. This keeps the deployed airbag angled away from the seated occupant, and because of the large space between the vehicle seat and the door panel, there is little or no chance that the airbag will rebound off the door panel to impact the occupant. In smaller vehicles, however, where it is necessary to reduce the angle between the airbag axis and the longitudinal seat axis, an airbag having a non-wedge shaped top aspect may deploy too closely to the seated occupant. In contrast, the airbag 14 of the present invention includes a generally wedge shaped top aspect, which allows the airbag apparatus 12 to be mounted to a portion of the seat 10 such that the airbag axis forms an angle with the longitudinal seat axis that is less than 30°. In particular, as shown in FIG. 5, the airbag axis 44 forms an angle with the longitudinal seat axis 42 that is approximately 22°. Because of the wedge shaped top aspect, the airbag 14 will not contact the door panel 40, nor will it be deployed too closely to an occupant seated in the seat 10.

As shown in FIG. 1, the generally wedge shaped side aspect of the airbag 14 helps to ensure that maximum loading is applied to the vehicle occupant, where the occupant is best suited to receive it. Although the generally wedge shaped side aspect of the airbag 14 may be configured with any dimensions effective to reduce loading on the thorax of the seated occupant, one such configuration is shown in FIG. 1. In particular, the seated occupant 24 may be a fifth percentile female side impact anthropometric test dummy (ATD), as used in vehicle safety testing.

The airbag 14, shown in FIG. 1, is configured such that the bottom edge 22 projects up and forward at such an angle, that at least ¼ of the length (L) of the dummy's arm 46 is outside the airbag 14, when the arm 46 is oriented at a 45° angle with respect to the neutral (down) position, as frequently used in vehicle safety testing. It is worth noting that the test dummy 24 has only an upper arm—i.e., an arm extending from shoulder to elbow; therefore, the length (L) is the length of only the upper arm. Such a configuration for an airbag has been shown to be effective to minimize the loading on the thorax of such a test dummy, both from direct contact by an airbag, as well as from the dummy's arm being forced into the thorax region by the airbag.

Because the present invention provides an airbag apparatus that minimizes loading on the thorax of the seated occupant, the pressure used to inflate the airbag can be greater than is typically used with side airbags. For example, many side airbags are inflated to only 10-15 pounds per square inch (psi). In contrast, the inflator 16 is configured to inflate the airbag 14 with a pressure that is at least 25 psi; of course, the pressure may be less if desired. Because the airbag 14 can be inflated to higher pressures than typical side airbags, it may be desirable to use a stronger material for the airbag 14, than is used for typical side airbags. For example, many side airbags are made from a 420 denier polymeric material, or the like. Such material may not perform well when exposed to the temperatures associated with an airbag that inflates to 25 psi in 20-60 milliseconds (ms). One material shown to be effective for use in an airbag, such as the airbag 14, is a 620 denier polymeric material.

In addition to using a stronger material, such as the 620 denier polymeric material, the airbag 14, as discussed above, also includes reinforced regions 35, 37—see FIG. 2. Also shown in FIG. 2 is a third reinforced region 51. The reinforced region 51 includes two additional layers of material sewn into the airbag 14 along the top edge 20. In addition, extra stitching (not shown) can be used to further reinforce this edge. The reinforced region 51 is oriented along a length of the airbag 14 in the direction of deployment. This helps to provide additional strength to the airbag 14 in a direction of high magnitude forces during deployment. Moreover, the airbag 14 may experience elevated temperatures, particularly in hot weather climates; the reinforced region 51 helps to compensate for any loss of material strength resulting from elevated temperatures. Thus, the present invention provides yet another advantage over typical side airbags: it safely allows the airbag to be inflated to a higher pressure to provide increased protection, while at the same time reducing the loading on the thorax of the seated occupant.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A side airbag apparatus for a vehicle, comprising:
an airbag having a generally wedge shaped rear aspect when deployed, the generally wedge shaped rear aspect narrowing from an upper region to a lower region, thereby inhibiting loading on the thorax of an occupant of the vehicle seated adjacent the deployed airbag; and
an inflator cooperating with the airbag to supply gas thereto, thereby facilitating deployment of the airbag.

2. The airbag apparatus of claim 1, wherein the airbag has a side aspect including a generally wedge shaped portion when the airbag is deployed, the generally wedge shaped portion including a posterior edge, a top edge extending forward from the posterior edge, and a bottom edge, at least a portion of the bottom edge extending forward and upward from the posterior edge, thereby further inhibiting loading on the thorax of an occupant of the vehicle seated adjacent the deployed airbag.

3. The airbag apparatus of claim 1, wherein the airbag has a generally wedge shaped top aspect when deployed, the generally wedge shaped top aspect narrowing from a posterior region to a front region.

4. The airbag apparatus of claim 1, wherein the airbag comprises a polymeric material of at least 600 denier.

5. The airbag apparatus of claim 1, wherein the inflator is configured to inflate the airbag to at least 25 pounds per square inch.

6. The airbag apparatus of claim 1, wherein the airbag includes a vent hole for venting gas from the airbag.

7. The airbag apparatus of claim 1, wherein the airbag includes a reinforced region for providing additional strength to the airbag.

8. An airbag apparatus for a vehicle, comprising:
an airbag having a generally wedge shaped rear aspect when deployed, the generally wedge shaped rear aspect narrowing from an upper region to a lower region, thereby inhibiting loading on the thorax of an occupant of the vehicle seated adjacent the deployed airbag, the airbag having a side aspect including first and second portions, the first portion being generally triangular and narrowing from a back region to a front region, thereby further inhibiting loading on the thorax of an occupant of the vehicle seated adjacent the deployed airbag, the second portion being contiguous with the first portion and including at least one mounting hole; and
an inflator configured for attachment to the airbag at the at least one mounting hole, and cooperating with the airbag to supply gas thereto, thereby facilitating deployment of the airbag.

9. The airbag apparatus of claim 8, wherein the airbag has a generally wedge shaped top aspect when deployed, the generally wedge shaped top aspect narrowing from a posterior region to the front region.

10. The airbag apparatus of claim 8, wherein the airbag comprises a polymeric material of at least 600 denier.

11. The airbag apparatus of claim 8, wherein the inflator is configured to inflate the airbag to at least 25 pounds per square inch.

12. The airbag apparatus of claim 8, wherein the airbag includes a vent hole for venting gas from the airbag.

13. A vehicle seat including a side airbag apparatus, the airbag apparatus comprising:
an airbag having a generally wedge shaped rear aspect when deployed, the generally wedge shaped rear aspect narrowing from an upper region to a lower region, thereby inhibiting loading on the thorax of an occupant of the vehicle seated adjacent the deployed airbag; and
an inflator mounted on a portion of the seat and cooperating with the airbag to supply gas thereto, thereby facilitating deployment of the airbag.

14. The vehicle seat of claim 13, wherein the airbag has a side aspect including a generally wedge shaped portion when the airbag is deployed, the generally wedge shaped portion including a posterior edge, a top edge extending forward from the posterior edge, and a bottom edge, at least a portion of the bottom edge extending forward and upward from the posterior edge, thereby further inhibiting loading on the thorax of an occupant of the vehicle seated adjacent the deployed airbag.

15. The vehicle seat of claim 14, wherein the side aspect of the airbag includes first and second portions, the first portion being generally triangular and narrowing from a back region to a front region, the second portion being contiguous with the first portion and including at least one mounting hole for attaching the airbag to the inflator.

16. The vehicle seat of claim 13, wherein the airbag comprises a polymeric material of at least 600 denier.

17. The vehicle seat of claim 13, wherein the inflator is configured to inflate the airbag to at least 25 pounds per square inch.

18. The vehicle seat of claim 13, wherein the airbag includes a vent hole for venting gas from the airbag.

19. The vehicle seat of claim 13, wherein the airbag has a generally wedge shaped top aspect when deployed, the generally wedge shaped top aspect narrowing from a posterior region to a front region.

20. The vehicle seat of claim 19, including a longitudinal seat axis, wherein the top aspect of the deployed airbag defines an airbag axis, and the inflator is mounted on a portion of the seat such that the airbag axis forms an angle of less than 30° with the longitudinal seat axis.
